(19) United States
(12) Patent Application Publication
(10) Pub. No.: US 2007/0258383 A1
(43) Pub. Date: Nov. 8, 2007

(54) Packet Loss Measurement Device and Error Rate Measurement Device Using the Same

(76) Inventor: Takeshi Wada, Kanagawa (JP)

Correspondence Address: GREER, BURNS & CRAIN, 300 S WACKER DR, 25TH FLOOR, CHICAGO, IL, 60606, US

(21) Appl. No.: 11/661,736

(22) PCT Filed: Sep. 5, 2005
(86) PCT No.: PCT/JP05/16236

§ 371 Date: Mar. 1, 2007

(30) Foreign Application Priority Data
Sep. 3, 2004 (JP) 2004-256767

(51) Int. Cl. G06F 11/00

(52) U.S. Cl. 370/252

(57) ABSTRACT

It is an object of the present invention to provide a packet loss measurement device capable of preventing a packet from being erroneously judged as being lost when packets transmitted through the same transmission path are received in an order different from the transmission order. In a packet loss measurement device 8 for measuring a packet loss on a transmission path by receiving packets respectively assigned with sequence numbers and transmitted in parallel through a plurality of transmission paths, the packet loss measurement device 8 comprises a counting unit 11 for counting the number of receptions of packets respectively assigned with sequence numbers for each of the sequence numbers, and a packet loss judging unit 12 for judging whether each of the packets is lost or not based on the number of receptions thus counted by the counting unit 11. The packet loss judging unit 12 is operative to judge whether each of the packets is lost or not by comparing a value calculated by subtracting the minimum number of receptions counted by the counting unit 11 from the maximum number of receptions counted by the counting unit 11 with a predetermined threshold value.

### TECHNICAL FIELD OF THE INVENTION

The present invention relates to a packet loss measurement device for measuring a packet loss, and more particularly to a packet loss measurement device for measuring a packet loss on a transmission path from among packets transmitted through a plurality of transmission paths.

### DESCRIPTION OF THE RELATED ART

As a packet loss measurement device for measuring a packet loss, there has been known, for example, a device adapted to receive packets transmitted via a plurality of transmission paths respectively through a plurality of receiving interfaces, identify a packet which may be lost by rearranging the received packets in accordance with sequence numbers attached to the respective packets, and judge the packet thus identified as being lost if packets greater in sequence number than the packet thus identified are received through all of the receiving interfaces connected with available transmission paths before the packet thus identified is received (see, for example, Patent document 1).

Patent document 1: Japanese Patent Laid-Open Publication No. 2001-244982

### DISCLOSURE OF THE INVENTION

### Problems to be Solved by the Invention

The conventional packet loss measurement device, however, encounters a drawback in that a packet may be erroneously judged as being lost if the packet transmitted through the transmission path is received in an order different from a transmission order.

The present invention is made for the purpose of overcoming the conventional problem, and it is an object of the present invention to provide a packet loss measurement device capable of preventing a packet from being erroneously judged as being lost even though packets transmitted through the same transmission path may be received in an order different from the transmission order.

### MEANS FOR SOLVING THE PROBLEMS

In accordance with a first aspect of the present invention, there is provided a packet loss measurement device for receiving a string of packets transmitted from a packet transmitting device (7) operative to sequentially transmit packets of a plurality of groups, which respectively have the same number of packets, one group after another on a transmission path, and judging whether or not a packet is lost on said transmission path, and in which packets of each of said groups are respectively assigned with packet identification numbers different from one another, and said packet identification numbers different from one another are common to all of said groups, and which comprising: a counting unit (11) for counting the number of receptions of packets respectively assigned with said packet identification numbers for each of said packet identification numbers; and a packet loss judging unit (12) for, in the case that a value calculated by subtracting the minimum number of receptions counted by said counting unit from the maximum number of receptions counted by said counting unit reaches a predetermined threshold value, judging a packet of said minimum number of receptions as being lost.

The packet loss measurement device according to the present invention thus constructed can prevent packets from being erroneously judged as being lost in the case that the packets transmitted through the same transmission path are received in an order different from the transmission order, resulting from the fact that each of the packets is judged as being lost or not by comparing the value calculated by subtracting the minimum number of receptions counted by the counting unit from the maximum number of receptions counted by the counting unit for each of the packet identification numbers with a predetermined threshold value.

Further, said packet identification numbers may be sequence numbers of each of said groups.

Further, said counting unit may subtract 1 from each number of receptions, which has been counted by said packet identification numbers and equal to or greater than one, in the case that all of said packets respectively assigned with sequence numbers of one cycle are received or at least one packet is judged by said packet loss judging unit as being lost.

The packet loss measurement device according to the present invention thus constructed can prevent erroneous judgment from being performed by the counting unit caused by wrong carry-over.

In accordance with a second aspect of the present invention, there is provided an error rate measurement device (20) according to the present invention, for measuring an error rate in an inputted digital data signal based on said digital data signal and a clock signal corresponding to said digital data signal, comprising the aforementioned packet loss measurement device, and in which a packet loss rate is calculated based on a total number of packets received by said packet loss measurement device within a predetermined measuring time, and a total number of lost packets measured by said packet loss measurement device within said measuring time.

The error rate measurement device according to the present invention is applicable to, for example, evaluation of network including switching equipment, resulting from the fact that the present embodiment of the error rate measurement device can evaluate error rate (quality) in digital signals as well as whether or not packets can be normally recognized when the packets are transmitted.

### ADVANTAGEOUS EFFECT OF THE INVENTION

The present invention can provide a packet loss measurement device capable of preventing a packet from being erroneously judged as being lost when packets transmitted through the same transmission path are received in an order different from the transmission order.

### BRIEF DESCRIPTION OF THE DRAWINGS

FIG. 1 is a block diagram showing an example f a network, to which a first preferred embodiment of a packet loss measurement device according to the present invention is applied.

FIG. 2 is a block diagram showing a construction of the first preferred embodiment of the packet loss measurement device according to the present invention.

FIG. 3 is a view explaining operation of a packet loss judging unit forming part of the first preferred embodiment of the packet loss measurement device according to the present invention.

FIG. 4 is a block diagram showing a second preferred embodiment of an error rate measurement device according to the present invention.

FIG. 5 is a data construction diagram showing a construction of a packet received by the second preferred embodiment of the error rate measurement device according to the present invention.

### EXPLANATION OF THE REFERENCE NUMERALS

1: network
2, 3, 4, 5, 6: switching unit
7: packet transmitting device
8: packet loss measurement device
10: packet receiving unit
11: counting unit
12: packet loss judging unit
13: packet loss counting unit
15, 16: counter
20: error rate measurement device
21: data storing unit
22: error judging unit
23: computing unit

### DETAILED DESCRIPTION OF THE PREFERRED EMBODIMENT

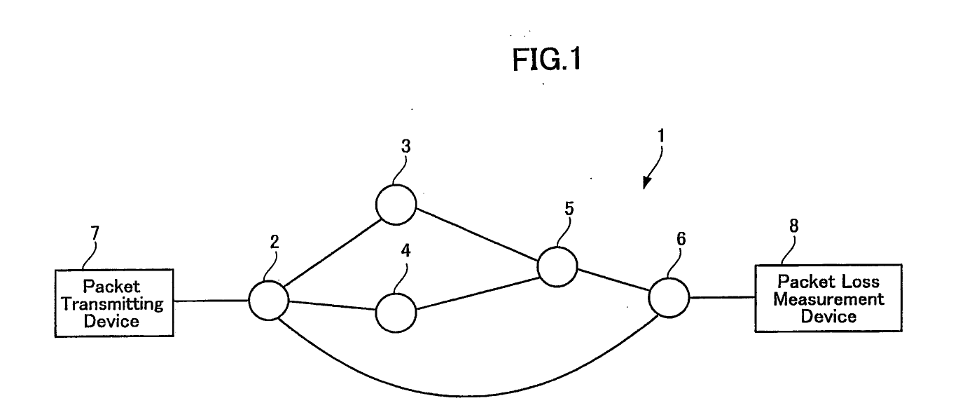

Preferred embodiments according to the present invention will be described hereinlater with reference to accompanying drawings. It is to be noted that the following embodiment is an example of applying a packet loss measurement device according to the present invention to a quality test of, for example, a network 1 shown in FIG. 1.

### First Preferred Embodiment

As shown in FIG. 1, the network 1 comprises a plurality of switching units 2 to 6. Here, the network 1 may be a optical communication network such as, for example, a photonic network for transmitting a packet in the form of light, or an electrical communication network such as, for example, an Internet network. If the network 1 is constituted by, for example, a photonic network, switching units 2 to 6 are respectively constituted by optical switching unit. If, on the other hand, the network 1 is constituted by the Internet network, the switching units 2 to 6 are respectively constituted by routers.

FIG. 1 shows a simple network construction for the purpose of facilitating understanding of the present invention. The packet loss measurement device according to the present invention may be applicable to a quality test of a network complex in construction, for example, further comprising a plurality of switching units.

The switching unit 2 is connected with a packet transmitting device 7 for sequentially transmitting packets of a plurality of groups, which respectively have the same number of packets, one group after another.

The packet transmitting device 7 is adapted to assign different packet identification numbers to respective packets of each of the groups, to ensure that the different packet identification numbers are common to all of the groups.

It is hereinlater assumed that a packet identification number in a group is a sequence number of a packet, and the group includes a plurality of packets equal in the number to the sequence numbers in one cycle. This means that if sequence numbers assigned by the packet transmitting device 7 to packets are, for example, 1 through 8, one is assigned to a packet firstly transmitted, eight is assigned to a packet eighth transmitted, one is assigned to a packet ninth transmitted, and the other sequence numbers are assigned to packets cyclically in the same manner.

The switching unit 6 is connected with a packet loss measurement device 8 for measuring a packet lost on a transmission path by receiving packets transmitted from the packet transmitting device 7.

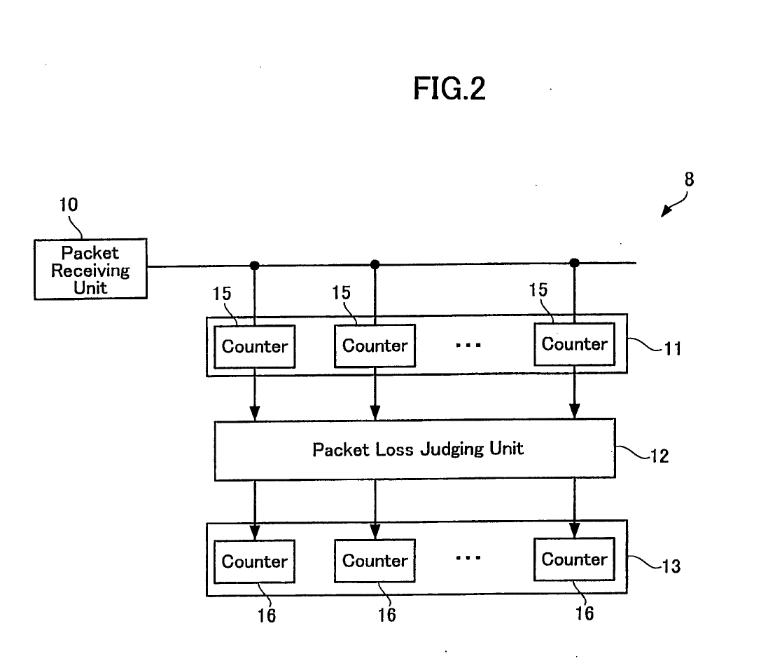

In FIG. 1, the transmission path from the packet transmitting device 7 to the packet loss measurement device 8 includes a first transmission path passing through the switching units 2, 3, 5 and 6, a second transmission path passing through the switching units, 2, 4, 5 and 6, and a third transmission path passing through the switching units 2 and 6. The packet transmitted through the first transmission path and the packet transmitted through the second transmission path may be exchanged with each other due to, for example, difference in band between the lines at the time when the packet is outputted from the switching unit 5. Further, the packets transmitted through the same transmission path may be changed in order due to, for example, priority control carried out by respective switching units. In view of the aforementioned matters, the packet loss measurement device 8 is constructed as shown in FIG. 2.

As shown in FIG. 2, the packet loss measurement device 8 comprises a packet receiving unit 10 for receiving packets transmitted from the packet transmitting device 7, a counting unit 11 for counting the number of receptions of packets, which sequence numbers are respectively assigned to, by the sequence numbers, a packet loss judging unit 12 for judging whether each of the packets is lost or not based on the number of receptions counted by the counting unit 11, and a packet loss counting unit 13 for counting the number of lost packets by the sequence numbers.

The packet receiving unit 10 is constituted by an O/E converting unit, a demultiplexing unit, or the like in the case that the network 1 is constituted by a photonic network, and by a network interface module, or the like, in the case that the network 1 is constituted by an Internet network.

The counting unit 11 is constituted by a plurality of counters 15 provided by the sequence numbers. This means if sequence numbers assigned by the packet transmitting device 7 to packets are, for example, 1 through 8, the counting unit 11 is constituted by eight counters 15.

Here, the counting unit 11 may decrement the number of receptions counted by each of the counters 15 by one in the case that all of the packets which sequence numbers of one cycle are respectively assigned to are successfully received or at least one packet is judged by the packet loss judging unit 12 as being lost, in order to prevent erroneous judgment from being performed by each of the counters 15 caused by wrong carry-over.

The packet loss judging unit 12 is adapted to judge whether or not each of the packets is lost by comparing a value calculated by subtracting the minimum number of receptions counted by the counting unit 11 from the maximum number of receptions counted by the counting unit 11 with a predetermined threshold value.

The packet loss judging unit 12 is constituted by, for example, a first comparator for determining the maximum number of receptions counted by the counting unit 11, a second comparator for determining the minimum number of receptions counted by the counting unit 11, a subtracter for calculating a value calculated by subtracting the minimum number of receptions counted by the counting unit 11 from the maximum number of receptions counted by the counting unit 11, a register for storing therein a threshold value, and a third comparator for comparing the result of calculation performed by the subtracter with the threshold value.

The packet loss counting unit 13 is constituted by a plurality of counters 16 equal in the number to the counters 15 of the counting unit 11, and each of the counters 16 is adapted to count the number of judgments made by the packet loss judging unit 12 that a packet of a concerned sequence number is lost. The number counted by the packet loss counting unit 13 is, for example, displayed by a monitor unit, or stored in a storage medium.

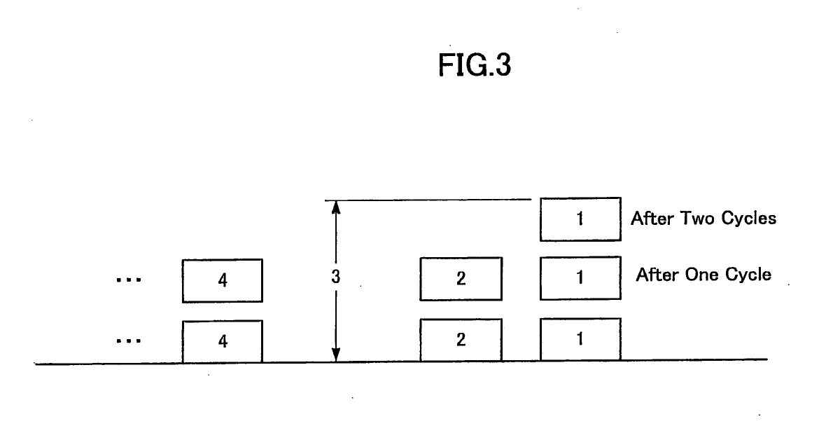

The operation of the packet loss measurement device 8 thus constructed as previously mentioned will be described hereinlater with reference to FIG. 2 and FIG. 3.

Firstly, packets transmitted by the packet transmitting device 7 are received by the packet receiving unit 10, and the number of receptions of the packets is counted by the counting unit 11 by the sequence numbers, and judgment is made by the packet loss judging unit 12 whether or not each of the packets is lost based on the number of receptions thus counted.

Here, the judgment by the packet loss judging unit 12 is carried out by comparing a value calculated by subtracting the minimum number of receptions counted by the counting unit 11 from the maximum number of receptions counted by the counting unit 11 with a predetermined threshold value.

In the case that the threshold value is set at, for example, three, as shown in FIG. 3, if a packet of the sequence number 3 is not received, but a packet of the sequence number 1 after two cycles is received by the packet receiving unit 10, the differential value between the number of receptions counted by the counter 15 for the sequence number 1 and the number of receptions counted by the counter 15 for the sequence number 3 becomes three, and thus reaches the threshold value, thereby causing the packet loss judging unit 12 to judge that the packet of the sequence number 3 is lost.

The packets judged by the packet loss judging unit 12 as being lost are counted by each of the counters 16 of the packet loss counting unit 13 by the sequence numbers.

While it has been described with reference to FIG. 3 that the threshold value is set at three, the packet loss measurement device 8 may allow a user to change the threshold value by operating an inputting unit such as, for example, a keyboard unit.

As will be appreciated from the foregoing description, it is to be understood that the present embodiment of the packet loss measurement device 8 according to the present invention can prevent a packet from being erroneously judged as being lost even though packets transmitted through the same transmission path are received in an order different from the transmission order, resulting from the fact that each of the packets is judged as being lost or not by comparing the value calculated by subtracting the minimum number of receptions counted by the counting unit 11 from the maximum number of receptions counted by the counting unit 11 for each of the sequence numbers with a predetermined threshold value.

### Second Preferred Embodiment

The first preferred embodiment of the packet loss measurement device 8 according to the present invention is applicable to an error rate measurement device for measuring an error rate in a digital signal based on an inputted digital data signal and a clock signal corresponding to the digital data signal. As a second preferred embodiment according to the present invention, an example of applying the first preferred embodiment of the packet loss measurement device 8 according to the present invention to the error rate measurement device will be described hereinlater.

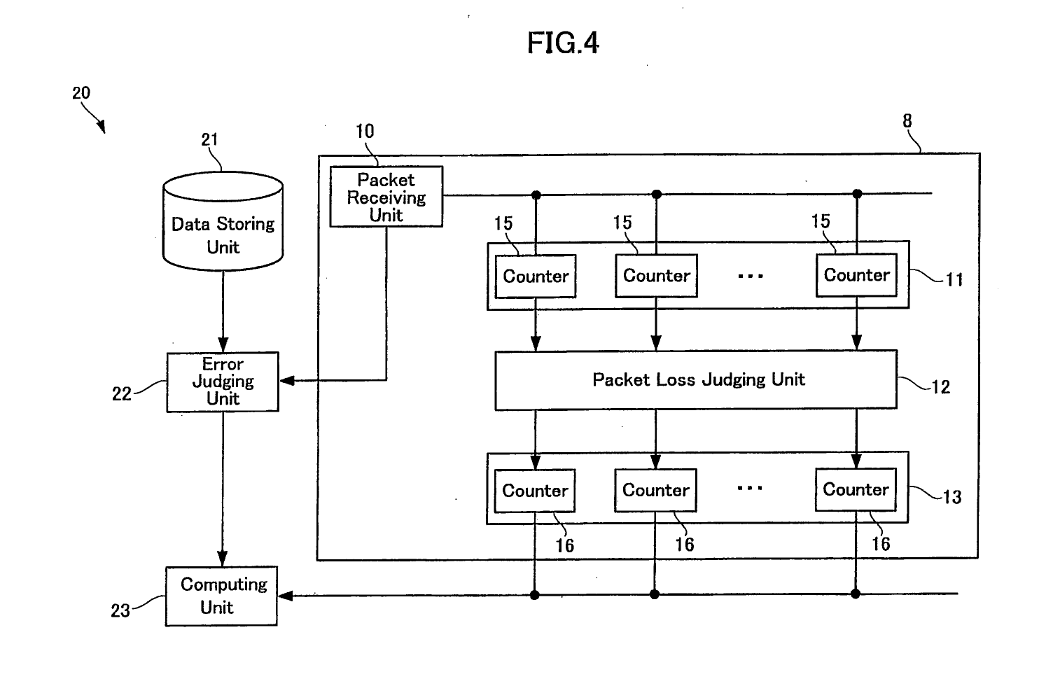

As shown in FIG. 4, the error rate measurement device 20 comprises a packet loss measurement device 8, a data storing unit 21 for storing therein verification data used to verify data contained in a packet, an error judging unit 22 for judging whether or not the packet received by the packet receiving unit 10 has an error based on the verification data, and a computing unit 23 for computing a bit error ratio and a packet loss rate.

The data storing unit 21 is constituted by a nonvolatile storage medium such as, for example, a hard disk, a flash memory, and/or the like, and store therein verification data of a plurality of pattern.

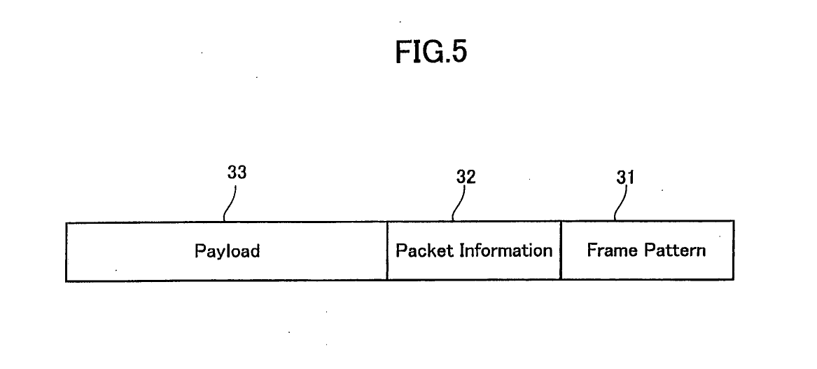

In the present embodiment, it is assumed that the packet received by the packet receiving unit 10 includes a frame pattern 31 indicative of a head of the packet, a packet information 32 having a storage address of the verification data in the data storing unit 21, a sequence number, and a packet length, and a pay load 33 indicative of data, as shown in FIG. 5.

The error judging unit 22 is constituted by a comparator, and adapted to obtain the verification data stored in the data storing unit 21 based on the storage address contained in the packet information 32 of the packet received by the packet receiving unit 10, and judge whether or not the data of the pay load 33 of the concerned packet is equivalent to the verification data thus obtained.

The computing unit 23 is constituted by, for example, a CPU (Central Processing Unit) executing a program, and adapted to calculate a bit error ratio based on the result of judgment made by the error judging unit 22.

Further, the computing unit 23 is adapted to compute a packet loss rate based on the total number of packets (hereinlater simply referred to as “the number of effective packets”) received by the packet loss measurement device 8 within a measuring time set by a measurer, and the total number of lost packets (hereinlater simply referred to as “the number of lost packets”) measured by the packet loss measurement device 8 within the above measuring time.

The computing unit 23 is adapted to calculate the packet loss rate in accordance with expression b/(a+b), wherein a is intended to mean the number of effective packets, b is intended to mean the number of lost packets. Here, the number of effective packets a is counted from the packet whose flame pattern 31 is currently detected after the measurement by the packet loss measurement device 8 is started.

The computing unit 23 may compute a packet loss rate by the sequence numbers. In this case, in addition to the number of effective packets a and the number of lost packets b, the computing unit 23 may compute the packet loss rate in accordance with expression c/{(a+b)/d}, wherein c is intended to mean the number of lost packets for the concerned sequence number, and d is intended to mean the number of sequence numbers of one cycle.

The bit error ratio of the packet corresponding to the identification number and the packet loss rate thus computed by the computing unit 23 are, for example, displayed by a monitor unit, or stored in a storage medium.

As will be appreciated from the foregoing description, it is to be understood that the present embodiment of the error rate measurement device 20 according to the present invention is applicable to, for example, evaluation of packet forwarding ability of network including switching equipment, resulting from the fact that the present embodiment of the error rate measurement device 20 can evaluate error rate (quality) in digital signals as well as whether or not packets can be normally recognized when the packets are transmitted.

What is claimed is:

1. A packet loss measurement device for receiving a string of packets transmitted from a packet transmitting device (7) operative to sequentially transmit packets of a plurality of groups, which respectively have the same number of packets, one group after another on a transmission path, and judging whether or not a packet is lost on said transmission path, and in which
packet identification numbers different from one another are respectively assigned to packets of each of said groups, and are common to all of said groups, and which comprising:
a counting unit (11) for counting the number of receptions of said packets by said packet identification numbers; and
a packet loss judging unit (12) for, in the case that a value calculated by subtracting the minimum number of receptions counted by said counting unit from the maximum number of receptions counted by said counting unit reaches a predetermined threshold value, judging a packet of said minimum number of receptions as being lost.

2. A packet loss measurement device as set forth in claim 1, in which said packet identification numbers are sequence numbers of each of said groups.

3. A packet loss measurement device as set forth in claim 1, in which said counting unit is operative to subtract 1 from each number of receptions, which has been counted by said packet identification numbers and equal to or greater than one, in the case that all of said packets of one group are received or at least one packet is judged by said packet loss judging unit as being lost.

4. An error rate measurement device (20) for measuring an error rate in an inputted digital data signal based on said digital data signal and a clock signal corresponding to said digital data signal, comprising a packet loss measurement device as set forth in claim 1, and in which a packet loss rate is calculated based on a total number of packets received by said packet loss measurement device within a predetermined measuring time, and a total number of lost packets measured by said packet loss measurement device within said measuring time.
